(19) United States
(12) Patent Application Publication
(10) Pub. No.: US 2025/0345643 A1
(43) Pub. Date: Nov. 13, 2025

(54) FIRE SUPPRESSION SYSTEM AND METHOD FOR A CARGO COMPARTMENT OF A VEHICLE

(71) Applicant: THE BOEING COMPANY, Arlington, VA (US)

(72) Inventor: Nels Andrew Olson, Seattle, WA (US)

(73) Assignee: THE BOEING COMPANY, Arlington, VA (US)

(21) Appl. No.: 18/659,080

(22) Filed: May 9, 2024

(51) Int. Cl. A62C 3/08; A62C 31/00; A62C 37/36

(52) U.S. Cl. CPC A62C 3/08; A62C 31/005; A62C 37/04

(57) ABSTRACT

A system and a method for suppressing a fire within a cargo compartment of a vehicle, include an outer support conduit having a first diameter, and a first tube having one or more portions retained within the outer support conduit. The first tube has a second diameter that is less than the first diameter. The outer support conduit is configured to deliver a first portion of a fire suppression agent around the one or more portions of the first tube, and the first tube is configured to deliver a second portion of the fire suppression agent.

### FIELD OF THE DISCLOSURE

Examples of the present disclosure generally relate to a fire suppression system and method, such as for a cargo compartment of a vehicle.

### BACKGROUND OF THE DISCLOSURE

Vehicles such as commercial aircraft are used to transport passengers and/or cargo between various locations. A typical aircraft includes an internal cabin having seats for passengers and a cargo compartment that may be below the passenger cabin. As another example, a freighter aircraft includes a main deck compartment. That is, a freighter aircraft can include an internal cabin dedicated to transporting cargo instead of passengers.

Certain aircraft include a cargo compartment for receiving and retaining cargo. A fire suppression system is disposed within the cargo compartment. The fire suppression system typically includes two sets of tubing for the delivery of binary fire suppression agents. Two sets of tubing are used because the fire suppression agent needs to be delivered to low-rate discharge nozzles as a liquid, and vaporized at a location of use. A second set of nozzles, those for high-rate discharge, have no such requirement for liquid delivery. Each set of tubing is secured within the cargo compartment with separate and distinct hangers, fittings, fasteners, and/or the like.

As can be appreciated, the use of multiple hangers, fittings, and fasteners to secure different sets of tubing within the cargo compartment adds weight and complexity to the overall system. Further, installing such a system within the cargo compartment is time and labor intensive.

### SUMMARY OF THE DISCLOSURE

A need exists for a lighter and less complex fire suppression system, such as can be used within a cargo compartment of a vehicle, such as an aircraft.

With that need in mind, certain examples of the present disclosure provide a system for suppressing a fire within a cargo compartment of a vehicle. The system includes an outer support conduit having a first diameter, and a first tube having one or more portions retained within the outer support conduit. The first tube has a second diameter that is less than the first diameter. The outer support conduit is configured to deliver a first portion of a fire suppression agent around the one or more portions of the first tube. The first tube is configured to deliver a second portion of the fire suppression agent.

In at least one example, the vehicle is an aircraft.

In at least one example, a first tank is in fluid communication with the first tube. The first tank is configured to retain the second portion of the fire suppression agent. A second tube is in fluid communication with the outer support conduit. A second tank is in fluid communication with the second tube. The second tank is configured to retain the first portion of the fire suppression agent. In at least one further example, a first valve is on or within the first tube, and a second valve is on or within the second tube. In at least one further example, a control unit is in communication with the first valve and the second valve. The control unit is configured to control operation of the first valve and the second valve. The system can also include one or more sensors configured to detect a fire. The control unit can be in communication the one or more sensors.

In at least one example, the outer support conduit forms at least a portion of the second tube. As another example, at least a portion of the second tube is retained within the outer support conduit.

The second diameter can be 10% or less of the first diameter.

The outer support conduit can be formed of a metal, and the first tube can be formed of a plastic.

In at least one example, one or more retainers are disposed within the outer support conduit. The one or more retainers are configured to retain the first tube at a desired position within the outer support conduit.

In at least one example, the one or more retainers include a cylindrical main body, a central channel configured to receive and retain a portion of the first tube, and one or more fluid passages formed through the cylindrical main body.

Certain examples of the present disclosure provide an aircraft including a cargo compartment, and a system for suppressing a fire within the cargo compartment, as described herein.

Certain examples of the present disclosure provide a method including delivering the first portion of the fire suppression agent through the outer support conduit around the one or more portions of the first tube; and delivering the second portion of the fire suppression agent through the first tube.

### BRIEF DESCRIPTION OF THE DRAWINGS

FIG. 1 illustrates a block diagram of a fire suppression system within a cargo compartment of an aircraft, according to an example of the present disclosure.

FIG. 2 illustrates a schematic diagram of the fire suppression system, according to an example of the present disclosure.

FIG. 3 illustrates a schematic diagram of the fire suppression system, according to an example of the present disclosure.

FIG. 4 illustrates an isometric view of an outer support conduit, according to an example of the present disclosure.

FIG. 5 illustrates an end view of a retainer, according to an example of the present disclosure.

FIG. 6 illustrates an end view of a retainer, according to an example of the present disclosure.

FIG. 7 illustrates an isometric view of an outer support conduit, according to an example of the present disclosure.

FIG. 8 illustrates a perspective front view of an aircraft, according to an example of the present disclosure.

FIG. 9 illustrates a flow chart of a method, according to an example of the present disclosure.

### DETAILED DESCRIPTION OF THE DISCLOSURE

The foregoing summary, as well as the following detailed description of certain embodiments will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular condition can include additional elements not having that condition.

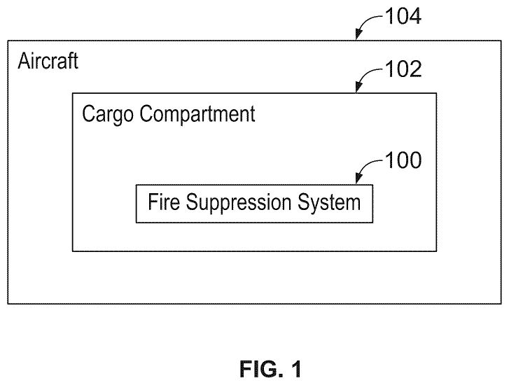

FIG. 1 illustrates a block diagram of a fire suppression system 100 within a cargo compartment 102 of an aircraft 104, according to an example of the present disclosure. The fire suppression system 100 includes components secured on or within a ceiling, walls, floor, and/or the like of the cargo compartment 102. Optionally, the fire suppression system 100 can be used in various other areas of the aircraft 104, such as within at least a portion of a passenger cabin. Further, examples of the present disclosure can be used with other types of vehicles, such as land-based vehicles, watercraft, spacecraft, or the like. As another example, examples of the present disclosure can be used with fixed structures, such as commercial or residential buildings.

Examples of the present disclosure provide a fire suppression system and method, such as can be disposed in a cargo compartment of a vehicle, such as a commercial aircraft.

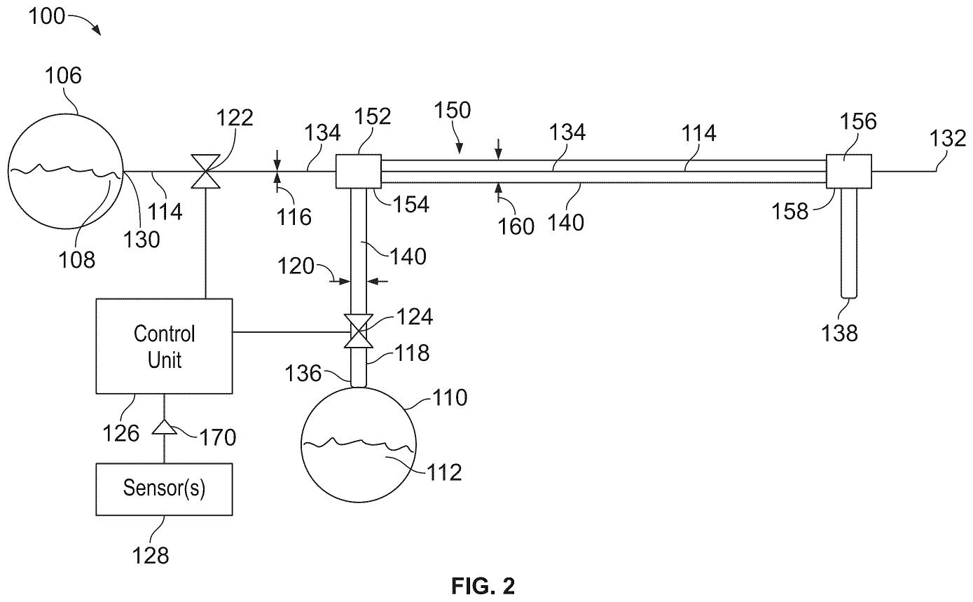

FIG. 2 illustrates a schematic diagram of the fire suppression system 100, according to an example of the present disclosure. The fire suppression system 100 includes a first tank 106 that retains a fire suppression agent 108, and a second tank 110 that retains a fire suppression agent 112. The fire suppression agent 108 and 112 is configured to be delivered as a liquid to delivery nozzles, and vaporized at a point of use. As an example, the fire suppression agent 108 and 112 can be or otherwise include a mixture of liquid carbon dioxide retaining bromine. In at least one example, the first tank 106 is a low rate tank configured to retain the fire suppression agent 108 to be delivered at a first rate, and the second tank 110 is a high rate tank configured to retain the fire suppression agent 112 to be delivered at a second rate, which is higher than the first rate.

It is to be understood that the terms first and second are merely for labeling purposes. The first tank 106 can be considered a second tank, and the second tank 110 can be considered a first tank.

The first tank 106 is in fluid communication with a first tube 114 having a first diameter 116. The first tube 114 defines a fluid passage formed therethrough. The first tube 114 is configured to convey fire suppressing agent through the fluid passage. The second tank 110 is in fluid communication with a second tube 118 having a second diameter 120. The second tube 118 defines a fluid passage formed therethrough. The second tube 118 is configured to convey fire suppressing agent through the fluid passage.

The diameter of the tube 114 is smaller than the diameter of the tube 118. In particular, the first diameter 116 is smaller than the second diameter 120. For example, the first diameter is 50% or smaller than the second diameter 120. As a further example, the first diameter is 10% or smaller than the second diameter 120.

A first valve 122 is disposed on and/or within the first tube 114, and a second valve 124 is disposed on and/or within the second tube 118. A control unit 126 is in communication with the first valve 122 and the second valve 124, such as through one or more wired or wireless connections. The first valve 122 and the second valve 124 are configured to be selectively operated by the control unit 126 to move between a closed position and an open position.

The first valve 122 is downstream from the first tank 106, and can be upstream from an outer support conduit 150. Similarly, the second valve 124 is downstream from the second tank 110, and can be upstream from the outer support conduit 150. Optionally, the first valve 122 and/or the second valve 124 can be disposed on and/or within the outer support conduit 150.

In at least one example, the control unit 126 is also in communication with one or more sensors 128, such as can be disposed throughout a cargo compartment. The sensor(s) 128 can include fire detectors, carbon monoxide detections, and/or the like. Optionally, the system 100 may not include the control unit 126. For example, the valves 122 and 124 can be directly in communication with the sensor(s) 128. As another example, the system 100 may not include the sensor(s) 128.

The first tube 114 includes an inlet end 130 at the first tank 106, and an outlet end 132 distally located from the inlet end 130. The outlet end 132 can include one or more delivery nozzles. The first tube 114 further includes a main tubular body 134 extending between the inlet end 130 and the outlet end 132.

The second tube 118 includes an inlet end 136 at the second tank 110, and an outlet end 138 distally located from the inlet end 136. The outlet end 138 can include one or more delivery nozzles. The second tube 118 further includes a main tubular body 140 extending between the inlet end 136 and the outlet end 138.

The fire suppression system 100 further includes the outer support conduit 150, such as a tubular body. The outer support conduit 150 retains at least a portion of the main tubular body 134 of the first tube 114. For example, the portion of the main tubular body 134 of the first tube 114 is retained within the outer support conduit 150. A first seal 152 is disposed at a first end 154 of the outer support conduit 150. The first seal 152 sealingly engages an outer surface of the main tubular body 134 of the first tube 114, and also sealingly engages an outer surface of the main tubular body 140 of the second tube 118. Similarly, a second seal 156 is disposed at a second end 158 (opposite from the first end 154) of the outer support conduit 150. The second seal 156 sealingly engages an outer surface of the main tubular body 134 of the first tube 114, and also sealingly engages an outer surface of the main tubular body 140 of the second tube 118.

In at least one example, a portion of the main tubular body 140 is retained within the outer support conduit 150. For example, a portion of the main tubular body 140 between the first seal 152 and the second seal 156 fits within, and is retained by, the outer support conduit 150. In this example, the outer support conduit 150 can have a diameter 160 larger than the diameter 120 of the second tube 118. As another example, the outer support conduit 150 provides the portion of the main tubular body 140 of the second tube 118 between the first seal 152 and the second seal 156. In this example, the diameter 160 is the same as the diameter 120.

In at least one example, the first tube 114 and the second tube 118 are formed of metal. For example, each of the first tube 114 and the second tube 118 can be formed of stainless steel, aluminum, titanium, or the like. As another example, one or both of the first tube 114 or the second tube 118 can be formed of a polymer, such as plastic. In at least one example, the first tube 114 is formed of a plastic, and the second tube 118 is formed of a metal. By forming the first tube 114 as a plastic, the first tube 114 can be more flexible and resilient. In this manner, the first tube 114 can be disposed within the outer support conduit 150, and more readily shaped in response to shaping of the outer support conduit 150. In at least one example, the outer support conduit 150 can be a metal, or a plastic.

Referring to FIGS. 1 and 2, in operation, in response to the sensor(s) 128 detecting a fire within the cargo compartment 102, the sensor(s) 128 output a fire detection signal 170, which is received by the control unit 126. In response to receiving the first detection signal 170, the control unit 126 opens the second valve 124. That is, the control unit 126 operates the second valve 124 to move into the open position. As the second valve 124 is opened, the fire suppression agent 112 moves into the second tube 118, and into the outer support conduit 150. The fire suppression agent 112 passing from the second tube 118 into the outer support conduit 150 flows around the main tubular body 134 of the first tube 114 retained within the outer support conduit 150. The larger diameter of the second tube 118 allows a high rate of the fire suppression agent 112 to be quickly delivered to a fire within the cargo compartment 102 through the outlet end 138.

After the fire suppression agent 112 from the second tube 118 is delivered to a fire within the cargo compartment 102, the control unit 126 opens the first valve 122, so that the fire suppression agent 108 within the first tank 106 passes through the first tube 114, and into the portion of the first tube 114 within the outer support conduit 150. The fire suppression agent 108 then passes out of the outlet end 132 of the first tube 114, such as within an area of the cargo compartment 102. Because the diameter 116 of the first tube 114 is substantially less than the diameter 120 of the second tube 118, the fire suppression agent 108 is delivered into the cargo compartment 102 at a substantially lower rate, over a longer period of time, as compared to the fire suppression agent 112 (which, conversely, is delivered at a substantially higher rate, over a shorter period of time, as compared to the fire suppression agent 108).

As described herein, examples of the present disclosure provide a fire extinguishing system configured to deliver a binary fire suppression agent to the cargo compartment 102 of the aircraft 104. The system 100 includes the outer support conduit 150, which includes a larger diameter portion (for example, a portion of the second tube 118) for delivery of the high rate discharge fire suppression agent 112, and a smaller diameter portion (for example, a portion of the first tube 114) for delivery of the low rate discharge fire suppression agent 108. By disposing the portion of the first tube 114 within the outer support conduit 150, a single set of pipe hangers can be used to secure the system 100 within the cargo compartment 102. The outer support conduit 150 allows for the delivery of high rate discharge fire suppression agent 112 and low rate fire suppression agent 108 within and through the same structure, thereby eliminating the need for two sets of pipe hangers and associated hardware and weight.

As used herein, the term “control unit,” “central processing unit,” “CPU,” “computer,” or the like may include any processor-based or microprocessor-based system including systems using microcontrollers, reduced instruction set computers (RISC), application specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the control unit 126 may be or include one or more processors that are configured to control operation, as described herein.

The control unit 126 is configured to execute a set of instructions that are stored in one or more data storage units or elements (such as one or more memories), in order to process data. For example, the control unit 126 may include or be coupled to one or more memories. The data storage units may also store data or other information as desired or needed. The data storage units may be in the form of an information source or a physical memory element within a processing machine.

The set of instructions may include various commands that instruct the control unit 126 as a processing machine to perform specific operations such as the methods and processes of the various examples of the subject matter described herein. The set of instructions may be in the form of a software program. The software may be in various forms such as system software or application software. Further, the software may be in the form of a collection of separate programs, a program subset within a larger program, or a portion of a program. The software may also include modular programming in the form of object-oriented programming. The processing of input data by the processing machine may be in response to user commands, or in response to results of previous processing, or in response to a request made by another processing machine.

The diagrams of examples herein may illustrate one or more control or processing units, such as the control unit 126. It is to be understood that the processing or control units may represent circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the control unit 126 may represent processing circuitry such as one or more of a field programmable gate array (FPGA), application specific integrated circuit (ASIC), microprocessor(s), and/or the like. The circuits in various examples may be configured to execute one or more algorithms to perform functions described herein. The one or more algorithms may include aspects of examples disclosed herein, whether or not expressly identified in a flowchart or a method.

As used herein, the terms “software” and “firmware” are interchangeable, and include any computer program stored in a data storage unit (for example, one or more memories) for execution by a computer, including RAM memory, ROM memory, EPROM memory, EEPROM memory, and non-volatile RAM (NVRAM) memory. The above data storage unit types are exemplary only, and are thus not limiting as to the types of memory usable for storage of a computer program.

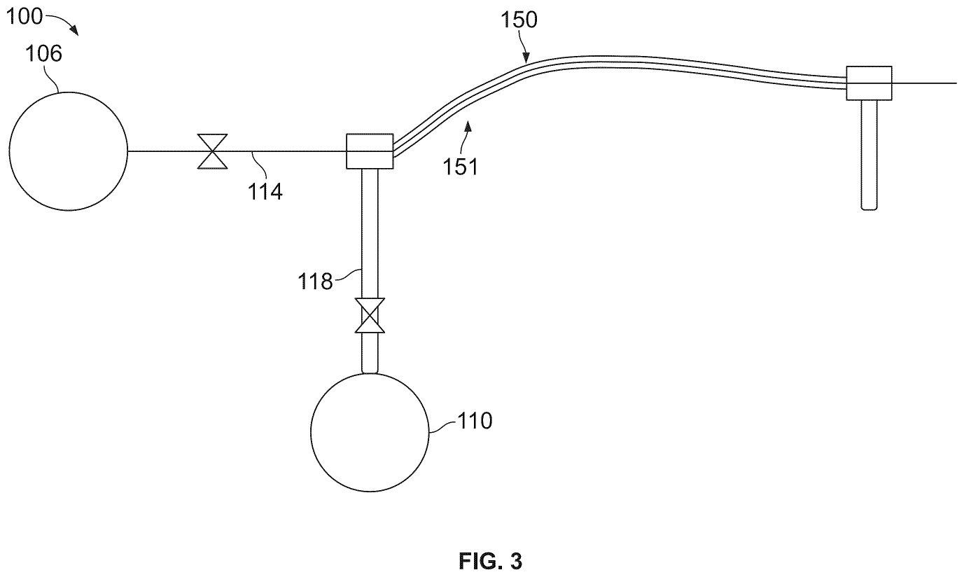

FIG. 3 illustrates a schematic diagram of the fire suppression system 100, according to an example of the present disclosure. As shown in FIG. 2, the outer support conduit 150 can be straight and linear. As shown in FIG. 2, the outer support conduit 150 can include one or more arcuate portions 151, such as curved or bent sections.

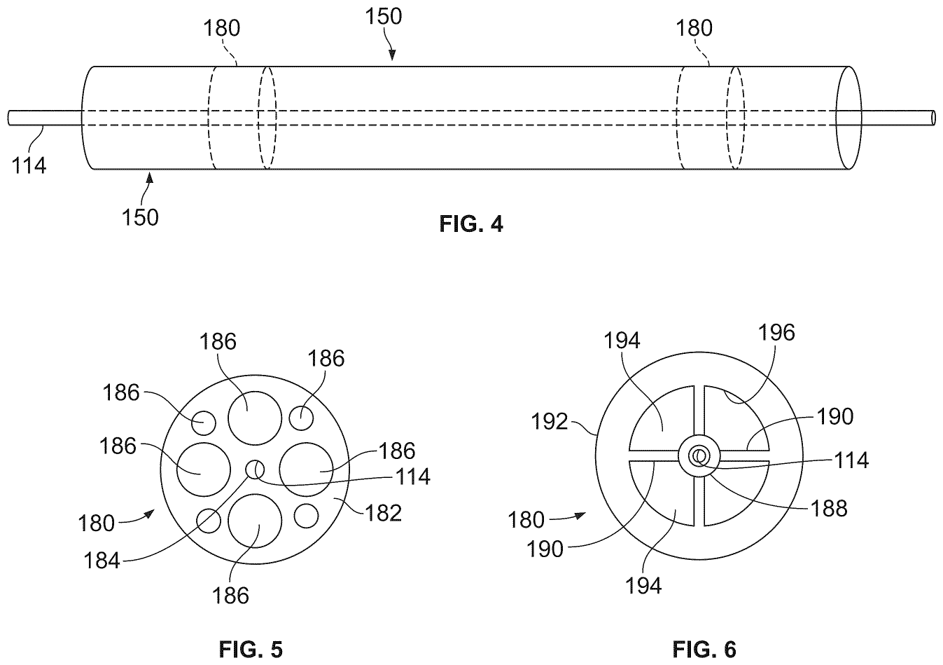

FIG. 4 illustrates an isometric view of the outer support conduit 150, according to an example of the present disclosure. In at least one example, the outer support conduit 150 includes one or more retainers 180. The outer support conduit 150 can include more or fewer retainers 180 than shown. Each retainer 180 is configured to support and retain a portion of the first tube 114 within the outer support conduit 150. In at least one example, the retainer 180 is disposed within the outer support conduit 150, and acts to ensure that the outer support conduit 150 remains open, while retaining the portion of the first tube 114 at a desired location (such as within a center) of the outer support conduit 150. The retainer 180 ensures a desired position of the portion of the tube 114 within the outer support conduit 150 when the outer support conduit 150 is bent, curved, or otherwise shaped for a particular installation.

Referring to FIGS. 1-4, examples of the present disclosure provide the system 100 for suppressing a fire within the cargo compartment 102 of a vehicle (such as the aircraft 104). The system 100 includes the outer support conduit 150 having the diameter 160. The system 100 also includes the first tube 114 having at least a portion retained within the outer support conduit 150. The first tube has the diameter 116, which is than the diameter 160. In at least one example, the outer support conduit 150 and the first tube 114 are coaxial. Optionally, the outer support conduit 150 and the first tube 114 might not be coaxial. An outer support conduit 150 is configured to deliver a first portion of a fire suppression agent, such as the fire suppression agent 112, around the at least a portion of the first tube 114. The first tube 114 is configured to deliver a second portion of the fire suppression agent, such as the fire suppression agent 108.

FIG. 5 illustrates an end view of the retainer 180, according to an example of the present disclosure. In at least one example, the retainer 180 is a disk having a cylindrical main body 182 configured to be disposed within a portion of the outer support conduit 150 (shown in FIG. 4). The main body 182 includes a central channel 184 (for example, an orifice) configured to receive and retain a portion of the first tube 114. That is, the portion of the first tube 114 fits within the central channel 184. Fluid passages 186 are formed through the main body 182 at radial positions outside of the central channel 184. The fluid passages 186 allow the fire suppression agent 112 to flow therethrough, while the fire suppression agent 108 is able to flow through the first tube 114 retained within the central channel 184.

The sizes and shapes of the fluid passages 186 shown in FIG. 5 are configured to allow for fluid flow therethrough, while the main body 182 provides robust structural support. Further, it has been found that by forming the fluid passages 186 as circular passages as shown, the process of manufacturing the retainer 180 is more efficient. Alternatively, the retainer 180 can include more or fewer fluid passages 186 than shown.

FIG. 6 illustrates an end view of a retainer 180, according to an example of the present disclosure. In this example, the retainer 180 includes a central retaining collar 188 that retains the portion of the first tube 114 therein. Linear ribs 190 connect the central retaining collar 188 to an outer ring 192. Fluid passages 194 are defined between the central retaining collar 188, the ribs 190, and the outer ring 196. The retainer 180 can include more or fewer ribs 190 than shown.

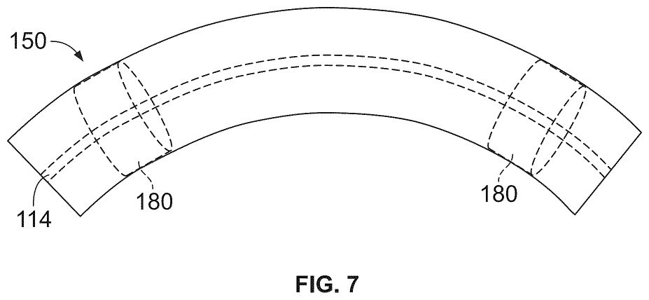

FIG. 7 illustrates an isometric view of the outer support conduit 150, according to an example of the present disclosure. The outer support conduit 150 can be bent, or otherwise curved, as shown in FIG. 7. The retainers 180 ensure that the first tube 114 remains centered within the outer support conduit 150.

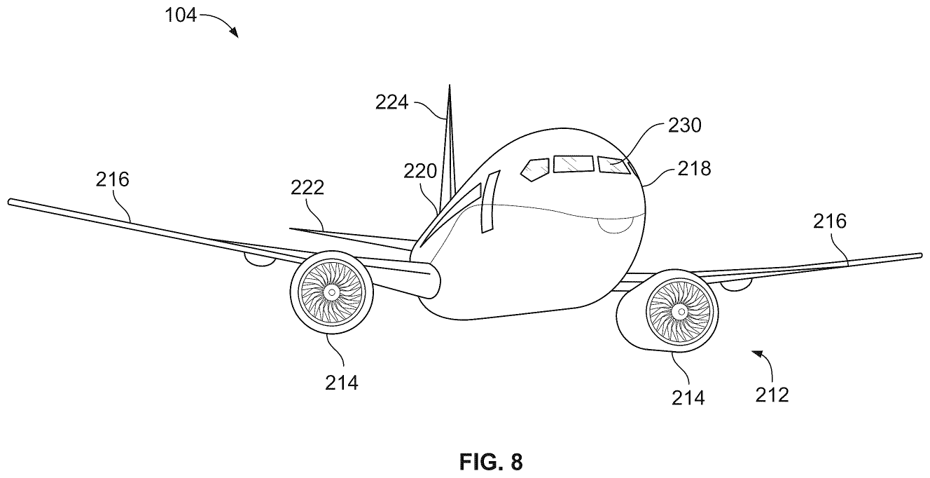

FIG. 8 illustrates a perspective front view of an aircraft 104, according to an example of the present disclosure. The aircraft 104 includes a propulsion system 212 that includes engines 214, for example. Optionally, the propulsion system 212 may include more engines 214 than shown. The engines 214 are carried by wings 216 of the aircraft 104. In other examples, the engines 214 may be carried by a fuselage 218 and/or an empennage 220. The empennage 220 may also support horizontal stabilizers 222 and a vertical stabilizer 224.

The fuselage 218 of the aircraft 104 defines an internal cabin 230. The internal cabin 230 includes a cargo compartment. For example, the cargo compartment can be a main deck cargo compartment. The internal cabin 230 can also include a passenger seating area. Optionally, the internal cabin may not include a passenger seating area. As another example, the cargo compartment can be outside of the internal cabin (such as underneath a floor).

Alternatively, instead of an aircraft, examples of the present disclosure may be used with various other vehicles, such as buses, locomotives and train cars, watercraft, spacecraft, and the like.

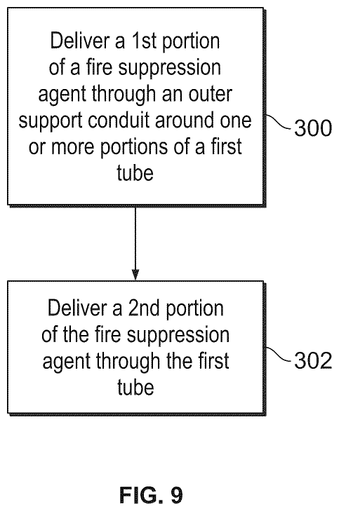

FIG. 9 illustrates a flow chart of a method, according to an example of the present disclosure. The method includes delivering, at 300, a first portion of fire suppression agent through an outer support conduit around one or more portions of the first tube; delivering, at 302, a second portion of the fire suppression agent through a first tube. In at least one example, the delivering 300 occurs during a first time period, and the delivering 302 during a second time period. The first time period can be substantially shorter than the second time period. For example, the first time period can be 10 minutes or less, and the second time period can be 60-180 minutes. Optionally, the first time period can be greater than 10 minutes. Also optionally, the second time period can be less than 60 minutes, or greater than 180 minutes.

Further, the disclosure comprises examples according to the following clauses:
Clause 1. A system for suppressing a fire within a cargo compartment of a vehicle, the system comprising:
an outer support conduit having a first diameter; and
a first tube having one or more portions retained within the outer support conduit, the first tube having a second diameter that is less than the first diameter,
wherein the outer support conduit is configured to deliver a first portion of a fire suppression agent around the one or more portions of the first tube, and wherein the first tube is configured to deliver a second portion of the fire suppression agent.
Clause 2. The system of Clause 1, wherein the vehicle is an aircraft.
Clause 3. The system of Clauses 1 or 2, further comprising:
a first tank in fluid communication with the first tube, wherein the first tank is configured to retain the second portion of the fire suppression agent; and
a second tube in fluid communication with the outer support conduit; and
a second tank in fluid communication with the second tube, wherein the second tank is configured to retain the first portion of the fire suppression agent.
Clause 4. The system of Clause 3, further comprising:
a first valve on or within the first tube; and
a second valve on or within the second tube.
Clause 5. The system of Clause 4, further comprising a control unit in communication with the first valve and the second valve, wherein the control unit is configured to control operation of the first valve and the second valve.
Clause 6. The system of Clause 5, further comprising one or more sensors configured to detect a fire, wherein the control unit is in communication the one or more sensors.
Clause 7. The system of any of Clauses 3-6, wherein the outer support conduit forms at least a portion of the second tube.
Clause 8. The system of any of Clauses 3-7, wherein at least a portion of the second tube is retained within the outer support conduit.
Clause 9. The system of any of Clauses 1-8, wherein the second diameter is 10% or less of the first diameter.
Clause 10. The system of any of Clauses 1-9, wherein the outer support conduit is formed of a metal, and the first tube is formed of a plastic.
Clause 11. The system of any of Clauses 1-10, further comprising one or more retainers disposed within the outer support conduit, wherein the one or more retainers are configured to retain the first tube at a desired position within the outer support conduit.
Clause 12. The system of any of Clause 11, wherein the one or more retainers comprise:
a cylindrical main body;
a central channel configured to receive and retain a portion of the first tube; and
one or more fluid passages formed through the cylindrical main body.
Clause 13. An aircraft comprising:
a cargo compartment; and
a system for suppressing a fire within the cargo compartment, the system comprising:
   an outer support conduit having a first diameter; and
   a first tube having one or more portions retained within the outer support conduit, the first tube having a second diameter that is less than the first diameter,
   wherein the outer support conduit is configured to deliver a first portion of a fire suppression agent around the one or more portions of the first tube, and wherein the first tube is configured to deliver a second portion of the fire suppression agent.
Clause 14. The aircraft of Clause 13, wherein the system further comprises:
a first tank in fluid communication with the first tube, wherein the first tank is configured to retain the second portion of the fire suppression agent;
a second tube in fluid communication with the outer support conduit;
a second tank in fluid communication with the second tube, wherein the second tank is configured to retain the first portion of the fire suppression agent;
a first valve on or within the first tube; and
a second valve on or within the second tube.
Clause 15. The aircraft of Clause 14, wherein the system further comprises:
a control unit in communication with the first valve and the second valve, wherein the control unit is configured to control operation of the first valve and the second valve;
and one or more sensors configured to detect a fire, wherein the control unit is in communication the one or more sensors.
Clause 16. The aircraft of Clauses 13 or 14, wherein the outer support conduit forms at least a portion of the second tube.
Clause 17. The aircraft of any of Clauses 13-16, wherein the second diameter is 10% or less of the first diameter.
Clause 18. The aircraft of any of Clauses 13-17, wherein the system further comprises one or more retainers disposed within the outer support conduit, wherein the one or more retainers are configured to retain the first tube at a desired position within the outer support conduit.
Clause 19. The aircraft of Clause 18, wherein the one or more retainers comprise:
a cylindrical main body;
a central channel configured to receive and retain a portion of the first tube; and
one or more fluid passages formed through the cylindrical main body.
Clause 20. A method for a system for suppressing a fire within a cargo compartment of a vehicle, the system comprising:
an outer support conduit having a first diameter; and
a first tube having one or more portions retained within the outer support conduit, the first tube having a second diameter that is less than the first diameter,
wherein the outer support conduit is configured to deliver a first portion of a fire suppression agent around the one or more portions of the first tube, and wherein the first tube is configured to deliver a second portion of the fire suppression agent,
the method comprising:
delivering the first portion of the fire suppression agent through the outer support conduit around the one or more portions of the first tube; and
delivering the second portion of the fire suppression agent through the first tube.

As described herein, examples of the present disclosure provide a relatively light and simple fire suppression system, which can be used within a cargo compartment of a vehicle, such as an aircraft.

While various spatial and directional terms, such as top, bottom, lower, mid, lateral, horizontal, vertical, front and the like can be used to describe embodiments of the present disclosure, it is understood that such terms are merely used with respect to the orientations shown in the drawings. The orientations can be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) can be used in combination with each other. In addition, many modifications can be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims and the detailed description herein, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112 (f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and can include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. A system for suppressing a fire within a cargo compartment of a vehicle, the system comprising:
an outer support conduit having a first diameter; and
a first tube having one or more portions retained within the outer support conduit, the first tube having a second diameter that is less than the first diameter,
wherein the outer support conduit is configured to deliver a first portion of a fire suppression agent around the one or more portions of the first tube, and wherein the first tube is configured to deliver a second portion of the fire suppression agent.

2. The system of claim 1, wherein the vehicle is an aircraft.

3. The system of claim 1, further comprising:
a first tank in fluid communication with the first tube, wherein the first tank is configured to retain the second portion of the fire suppression agent; and
a second tube in fluid communication with the outer support conduit; and
a second tank in fluid communication with the second tube, wherein the second tank is configured to retain the first portion of the fire suppression agent.

4. The system of claim 3, further comprising:
a first valve on or within the first tube; and
a second valve on or within the second tube.

5. The system of claim 4, further comprising a control unit in communication with the first valve and the second valve, wherein the control unit is configured to control operation of the first valve and the second valve.

6. The system of claim 5, further comprising one or more sensors configured to detect a fire, wherein the control unit is in communication the one or more sensors.

7. The system of claim 3, wherein the outer support conduit forms at least a portion of the second tube.

8. The system of claim 3, wherein at least a portion of the second tube is retained within the outer support conduit.

9. The system of claim 1, wherein the second diameter is 10% or less of the first diameter.

10. The system of claim 1, wherein the outer support conduit is formed of a metal, and the first tube is formed of a plastic.

11. The system of claim 1, further comprising one or more retainers disposed within the outer support conduit, wherein the one or more retainers are configured to retain the first tube at a desired position within the outer support conduit.

12. The system of claim 11, wherein the one or more retainers comprise:
a cylindrical main body;
a central channel configured to receive and retain a portion of the first tube; and
one or more fluid passages formed through the cylindrical main body.

13. An aircraft comprising:
a cargo compartment; and
a system for suppressing a fire within the cargo compartment, the system comprising:
an outer support conduit having a first diameter; and
a first tube having one or more portions retained within the outer support conduit, the first tube having a second diameter that is less than the first diameter,
wherein the outer support conduit is configured to deliver a first portion of a fire suppression agent around the one or more portions of the first tube, and wherein the first tube is configured to deliver a second portion of the fire suppression agent.

14. The aircraft of claim 13, wherein the system further comprises:
a first tank in fluid communication with the first tube, wherein the first tank is configured to retain the second portion of the fire suppression agent;
a second tube in fluid communication with the outer support conduit;
a second tank in fluid communication with the second tube, wherein the second tank is configured to retain the first portion of the fire suppression agent;
a first valve on or within the first tube; and
a second valve on or within the second tube.

15. The aircraft of claim 14, wherein the system further comprises:
a control unit in communication with the first valve and the second valve, wherein the control unit is configured to control operation of the first valve and the second valve; and
one or more sensors configured to detect a fire, wherein the control unit is in communication the one or more sensors.

16. The aircraft of claim 13, wherein the outer support conduit forms at least a portion of the second tube.

17. The aircraft of claim 13, wherein the second diameter is 10% or less of the first diameter.

18. The aircraft of claim 13, wherein the system further comprises one or more retainers disposed within the outer support conduit, wherein the one or more retainers are configured to retain the first tube at a desired position within the outer support conduit.

19. The aircraft of claim 18, wherein the one or more retainers comprise:
a cylindrical main body;
a central channel configured to receive and retain a portion of the first tube; and
one or more fluid passages formed through the cylindrical main body.

20. A method for a system for suppressing a fire within a cargo compartment of a vehicle, the system comprising:
an outer support conduit having a first diameter; and
a first tube having one or more portions retained within the outer support conduit, the first tube having a second diameter that is less than the first diameter,
wherein the outer support conduit is configured to deliver a first portion of a fire suppression agent around the one or more portions of the first tube, and wherein the first tube is configured to deliver a second portion of the fire suppression agent,
the method comprising:
delivering the first portion of the fire suppression agent through the outer support conduit around the one or more portions of the first tube; and
delivering the second portion of the fire suppression agent through the first tube.
